(19) United States
(12) Patent Application Publication
(10) Pub. No.: US 2025/0219436 A1
(43) Pub. Date: Jul. 3, 2025

(54) CHARGING SYSTEM, POWER-SUPPLY ADAPTER, CHARGER, AND METHOD FOR CONTROLLING CHARGER

(71) Applicant: MAKITA CORPORATION, Anjo-shi (JP)

(72) Inventor: Masaya MIZUTANI, Anjo-shi (JP)

(73) Assignee: MAKITA CORPORATION, Anjo-shi (JP)

(21) Appl. No.: 19/002,892

(22) Filed: Dec. 27, 2024

(30) Foreign Application Priority Data
Dec. 27, 2023 (JP) 2023-221366

(51) Int. Cl. H02J 7/06; H02J 7/00

(52) U.S. Cl. CPC H02J 7/06; H02J 7/0013; H02J 7/0042; H02J 7/0047; H02J 2207/20

(57) ABSTRACT

One aspect of the present disclosure provides a charging system including a power-supply adapter and a charger. The power-supply adapter includes a power conversion circuit and a state detection circuit. The charger includes at least one attachment and a charging circuit. The state detection circuit (i) generates a state indicating signal, (ii) transmits the state indicating signal to an electrical cable, and (iii) varies the state indicating signal in accordance with a state of the power-supply adapter. The charging circuit (i) receives DC power and the state indicating signal from the power-supply adapter via the electrical cable and (ii) varies charging power for charging at least one battery pack in accordance with a variation in the state indicating signal.

### CROSS-REFERENCE TO RELATED APPLICATIONS

This application claims the benefit of Japanese Patent Application No. 2023-221366 filed on Dec. 27, 2023 with the Japan Patent Office, the entire disclosure of which is incorporated herein by reference.

### BACKGROUND

The present disclosure relates to charging of a battery pack.

US 2019/0288534 A1 discloses a charging apparatus that comprises an adapter housing and a charging base housing and that is configured to charge various energy storage apparatuses. The adapter housing and the charging base housing are separate from each other and are connected through an electrical cable. In the adapter housing, a power supply conversion circuit is disposed. The power supply conversion circuit is configured to convert external power supply into charging energy. In the charging base housing, a charging circuit and a control circuit are at least partially disposed.

### SUMMARY

In the charging apparatus described above, neither the charging circuit nor the control circuit in the charging base housing can be controlled in accordance with the state of the power supply conversion circuit in the adapter housing.

It is desirable that one aspect of the present disclosure can control a charger in accordance with a state of a power-supply adapter.

One aspect of the present disclosure provides a charging system including a power-supply adapter and a charger.

The power-supply adapter includes a power conversion circuit and a state detection circuit. The power conversion circuit (i) receives AC power from an AC power supply, (ii) converts the AC power into DC power, and (iii) delivers the DC power to an electrical cable. The state detection circuit (i) generates a state indicating signal, (ii) transmits the state indicating signal to the electrical cable, and (iii) varies the state indicating signal in accordance with a state of the power-supply adapter.

The charger includes at least one attachment and a charging circuit. The at least one attachment is configured such that at least one battery pack is detachably attached thereto. The at least one battery pack is configured to be detachably attached to an electric-powered work machine. The charging circuit (i) receives the DC power and the state indicating signal from the power-supply adapter via the electrical cable, (ii) generates, based on the DC power, charging power for charging the at least one battery pack, (iii) delivers the charging power to the at least one battery pack attached to the at least one attachment, and (iv) varies the charging power in accordance with a variation in the state indicating signal.

In such a charging system, the charger can be controlled in accordance with the state of the power-supply adapter by the state indicating signal.

Another aspect of the present disclosure provides a power-supply adapter including a power conversion circuit and a state detection circuit.

The power conversion circuit (i) receives AC power from an AC power supply, (ii) converts the AC power into DC power, and (iii) delivers the DC power to a charger via an electrical cable.

The state detection circuit (i) generates a state indicating signal, (ii) transmits the state indicating signal to the charger via the electrical cable, and (iii) varies the state indicating signal in accordance with a state of the power-supply adapter.

Such a power-supply adapter can control the charger in accordance with the state of the power-supply adapter by the state indicating signal.

Still another aspect of the present disclosure provides a charger including at least one attachment and a charging circuit.

The at least one attachment is configured such that at least one battery pack is detachably attached thereto. The at least one battery pack is configured to be detachably attached to an electric-powered work machine.

The charging circuit (i) receives DC power and a state indicating signal from a power-supply adapter via an electrical cable, (ii) generates, based on the DC power, charging power for charging the at least one battery pack, (iii) delivers the charging power to the at least one battery pack attached to the at least one attachment, and (iv) varies the charging power in accordance with a variation in the state indicating signal. The state indicating signal varies in accordance with a state of the power-supply adapter.

Such a charger can be controlled in accordance with the state of the power-supply adapter by the state indicating signal.

Still another aspect of the present disclosure provides a method for controlling a charger, the method including:
transmitting a state indicating signal from a power-supply adapter to the charger via an electrical cable, wherein the state indicating signal varies in accordance with a state of the power-supply adapter; and
varying charging power in the charger in accordance with a variation in the state indicating signal, the charging power being power for charging a battery pack attached to the charger, and the battery pack being configured to be detachably attached to an electric-powered work machine.

According to such a method, the charger can be controlled in accordance with the state of the power-supply adapter.

### BRIEF DESCRIPTION OF THE DRAWINGS

Example embodiments of the present disclosure will be described hereinafter with reference to the accompanying drawings, in which:

FIG. 1 is a perspective view of a charging system in one embodiment;

FIG. 2 is a perspective view of a charger with a lid body removed;

FIG. 3 schematically shows an arrangement of attachments and indicators in the charger;

FIG. 4 is a block diagram showing an electrical configuration of the charger;

FIG. 5 is a circuit diagram showing an electrical configuration of a power-supply adapter;

FIG. 6 is a flowchart of a temperature controlling process executed by an adapter controller; and

FIG. 7 is a timing diagram showing an example of operations in the power-supply adapter and the charger.

### DETAILED DESCRIPTION OF EXEMPLARY EMBODIMENTS

### 1. Overview of Embodiments

In this disclosure, terms such as “first” and “second” are intended only to distinguish elements from one another and are not intended to limit the order or the number of elements. Therefore, a first element may be referred to as a second element, and likewise, the second element may be referred to as a first element. In addition, the first element may be provided without the second element, and likewise, the second element may be provided without the first element.

One embodiment may provide a charging system including at least any one of:
Feature 1: a power-supply adapter;
Feature 2: the power-supply adapter includes a power conversion circuit configured (i) to receive AC power from an AC power supply, (ii) to convert the AC power into DC power, and (iii) to deliver the DC power to an electrical cable;
Feature 3: the power-supply adapter includes a state detection circuit configured (i) to generate a state indicating signal, (ii) to transmit the state indicating signal to the electrical cable, and (iii) to vary the state indicating signal in accordance with a state of the power-supply adapter;
Feature 4: a charger;
Feature 5: the charger includes at least one attachment configured such that at least one battery pack is detachably attached thereto;
Feature 6: the at least one battery pack is configured to be detachably attached to an electric-powered work machine; and
Feature 7: the charger includes a charging circuit configured (i) to receive the DC power and the state indicating signal from the power-supply adapter via the electrical cable, (ii) to generate, based on the DC power, charging power for charging the at least one battery pack, (iii) to deliver the charging power to the at least one battery pack attached to the at least one attachment, and (iv) to vary the charging power in accordance with a variation in the state indicating signal.

In the charging system including at least Features 1 through 7, the charger can be controlled in accordance with the state of the power-supply adapter by the state indicating signal.

One embodiment may include, in addition to or in place of at least any one of Features 1 through 7,
Feature 8: the state detection circuit is configured to vary (i) the state indicating signal and (ii) an operation of the power conversion circuit, in accordance with the state of the power-supply adapter.

In the charging system including at least Features 1 through 8, both the charger and the power-supply adapter can be controlled in accordance with the state of the power-supply adapter.

One embodiment may include, in addition to or in place of at least any one of Features 1 through 8,
Feature 9: the charging system has a time interval between (i) a first timing at which the state detection circuit varies the operation of the power conversion circuit in response to the variation in the state indicating signal and (ii) a second timing at which the charging circuit varies the charging power in response to the variation in the state indicating signal.

In the charging system including at least Features 1 through 9, the charging power can be varied at a timing different from the DC power.

One embodiment may include, in addition to or in place of at least any one of Features 1 through 9, at least any one of:
Feature 10: the charging circuit is configured to increase the charging power in response to a first waiting time having elapsed after the variation in the state indicating signal into a first state; and
Feature 11: the first waiting time is longer than a time for the state detection circuit to vary the operation of the power conversion circuit so as to increase the DC power in response to the variation in the state indicating signal into the first state.

The charging system including at least Features 1 through 9, 10, and 11 can inhibit a situation from occurring where the charging power is increased before the DC power is increased such that the DC power is insufficient for generating the charging power.

One embodiment may include, in addition to or in place of at least any one of Features 1 through 11, at least any one of:
Feature 12: the state detection circuit is configured to vary the operation of the power conversion circuit so as to decrease the DC power in response to a second waiting time having elapsed after the variation in the state indicating signal into a second state; and
Feature 13: the second waiting time is longer than a time for the charging circuit to decrease the charging power in response to the variation in the state indicating signal into the second state.

The charging system including at least Features 1 through 9, 12, and 13 can inhibit a situation from occurring where the DC power is decreased before the charging power is decreased such that the DC power is insufficient for generating the charging power.

One embodiment may include, in addition to or in place of at least any one of Features 1 through 13, at least any one of:
Feature 14: the state detection circuit includes at least one temperature sensor configured to detect a temperature at a prespecified portion in the power conversion circuit; and
Feature 15: the state detection circuit is configured to vary the state indicating signal in accordance with the temperature detected by the at least one temperature sensor.

In the charging system including at least Features 1 through 7, 14, and 15, the charger can be controlled in accordance with the temperature of the prespecified portion in the power conversion circuit.

One embodiment may include, in addition to or in place of at least any one of Features 1 through 15, at least any one of:
Feature 16: the power conversion circuit includes a primary circuit including a primary winding;
Feature 17: the power conversion circuit includes a secondary circuit including a secondary winding that is configured to be inductively coupled with the primary winding;
Feature 18: the at least one temperature sensor includes a first temperature sensor configured to detect a first temperature at a first portion in the primary circuit;
Feature 19: the at least one temperature sensor includes a second temperature sensor configured to detect a second temperature at a second portion in the secondary circuit; and
Feature 20: the state detection circuit is configured to vary the state indicating signal in accordance with (i) the first temperature detected by the first temperature sensor and (ii) the second temperature detected by the second temperature sensor.

In the charging system including at least Features 1 through 7 and 14 through 20, the charger can be controlled in accordance with (i) the first temperature at the first portion in the primary circuit and (ii) the second temperature at the second portion in the secondary circuit.

The primary winding may be galvanically isolated from the secondary winding or may be electrically coupled with the secondary winding.

One embodiment may include, in addition to or in place of at least any one of Features 1 through 20, at least any one of:
Feature 21: the state detection circuit is configured to set the state indicating signal to a first logic level in response to either the first temperature or the second temperature having exceeded a first threshold;
Feature 22: the state detection circuit is configured to set the state indicating signal to a second logic level in response to both the first temperature and the second temperature having fallen below a second threshold; and
Feature 23: the second logic level is different from the first logic level.

In the charging system including at least Features 1 through 7 and 14 through 23, the state indicating signal can be (i) set to the first logic level in response to either the first temperature or the second temperature having exceeded the first threshold and (ii) set to the second logic level in response to both the first temperature and the second temperature having fallen below the second threshold.

The second threshold may be equal to the first threshold or may be lower than the first threshold.

One embodiment may include, in addition to or in place of at least any one of Features 1 through 23,
Feature 24: the power-supply adapter includes an indicator configured to indicate the state of the power-supply adapter.

The charging system including at least Features 1 through 7, and 24 can notify a user of the state of the power-supply adapter.

One embodiment may include, in addition to or in place of at least any one of Features 1 through 24, at least any one of:
Feature 25: the power-supply adapter includes an adapter main body including the power conversion circuit and the state detection circuit;
Feature 26: the electrical cable includes a first end coupled to the adapter main body;
Feature 27: the electrical cable includes a second end including a first connector; and
Feature 28: the charger includes a second connector configured to be detachably coupled to the first connector.

In the charging system including at least Features 1 through 7 and 25 through 28, the power-supply adapter can be detachably coupled to the charger. Thus, the user can (i) store the power-supply adapter separately from the charger when the charger is not in use or (ii) carry the power-supply adapter separately from the charger when the charger is moved. Therefore, the convenience of the charging system can improve.

One embodiment may include, in addition to or in place of at least any one of Features 1 through 28,
Feature 29: the at least one attachment includes two or more attachments configured such that two or more battery packs are detachably attached thereto.

The charging system including at least Features 1 through 7, and 29 can charge the two or more battery packs.

One embodiment may include, in addition to or in place of at least any one of Features 1 through 29,
Feature 30: the charger includes a charger main body (i) including therein the at least one attachment and the charging circuit and (ii) configured to store the at least one battery pack attached to the at least one attachment therein.

One embodiment may include, in addition to or in place of at least any one of Features 1 through 30, at least any one of:
Feature 31: the charger main body includes a container portion for storing the at least one battery pack therein; and
Feature 32: the charger includes a lid body configured to open and close the container portion.

The charging system including at least Features 1 through 7 and 30 through 32 can protect the at least one battery pack attached to the at least one attachment by the charger main body.

One embodiment may include, in addition to or in place of at least any one of Features 1 through 32,
Feature 33: the power conversion circuit is configured to provide a galvanic isolation between its AC input and its DC output.

The charging system including at least Features 1 through 7 and 33 can inhibit the user from getting electrocuted by the AC power.

One embodiment may include, in addition to or in place of at least any one of Features 1 through 33, at least any one of:
Feature 34: the state detection circuit includes a first electronic circuit electrically coupled to the AC power supply;
Feature 35: the state detection circuit includes a second electronic circuit electrically coupled to the electrical cable; and
Feature 36: the state detection circuit includes an optoisolator configured to optically couple the first electronic circuit with the second electronic circuit so as to transmit an electrical signal between the first electronic circuit and the second electronic circuit.

The charging system including at least Features 1 through 7 and 34 through 36 can transmit the electrical signal between the first electrical circuit and the second electrical circuit while inhibiting the user from getting electrocuted by the AC power.

Examples of the optoisolator include an optocoupler (or a photocoupler), an opto-emulator, and a solid-state relay (SSR).

One embodiment may include a mechanical relay in place of the optoisolator.

One embodiment may provide a power-supply adapter including at least any one of:
Feature 37: a power conversion circuit configured (i) to receive AC power from an AC power supply, (ii) to convert the AC power into DC power, and (iii) to deliver the DC power to a charger via an electrical cable; and
Feature 38: a state detection circuit configured (i) to generate a state indicating signal, (ii) to transmit the state indicating signal to the charger via the electrical cable, and (iii) to vary the state indicating signal in accordance with a state of the power-supply adapter.

The power-supply adapter including at least Features 37 and 38 can control the charger in accordance with the state of the power-supply adapter by the state indicating signal.

One embodiment may provide a charger including at least any one of:
Feature 39: at least one attachment configured such that at least one battery pack is detachably attached thereto;
Feature 40: the at least one battery pack is configured to be detachably attached to an electric-powered work machine;
Feature 41: the charging circuit configured (i) to receive DC power and a state indicating signal from a power-supply adapter via an electrical cable, (ii) to generate, based on the DC power, charging power for charging the at least one battery pack, (iii) to deliver the charging power to the at least one battery pack attached to the at least one attachment, and (iv) to vary the charging power in accordance with a variation in the state indicating signal; and
Feature 42: the state indicating signal varies in accordance with a state of the power-supply adapter.

The charger including at least Features 39 through 42 can be controlled in accordance with the state of the power-supply adapter by the state indicating signal.

One embodiment may provide a method including at least any one of:
Feature 43: transmitting a state indicating signal from a power-supply adapter to a charger via an electrical cable;
Feature 44: the state indicating signal varies in accordance with a state of the power-supply adapter;
Feature 45: varying charging power in the charger in accordance with a variation in the state indicating signal;
Feature 46: the charging power is power for charging a battery pack attached to the charger; and
Feature 47: the battery pack is configured to be detachably attached to an electric-powered work machine.

According to the method including at least Features 43 through 47, the charger can be controlled in accordance with the state of the power-supply adapter.

Examples of the electric-powered work machine include various electric apparatus used in job sites, such as do-it-yourself carpentry, manufacturing, gardening, and construction. Specifically, examples of the electric-powered work machine include an electric power tool for masonry work, metalworking, or woodworking, a work machine for gardening, and a device for preparing an environment of a job site. More specifically, examples of the electric-powered work machine include an electric blower, an electric hammer, an electric hammer drill, an electric drill, an electric driver, an electric wrench, an electric grinder, an electric circular saw, an electric reciprocating saw, an electric jigsaw, an electric cutter, an electric chainsaw, an electric planer, an electric nail gun (including a tacker), an electric hedge trimmer, an electric lawn mower, an electric lawn trimmer, an electric bush cutter, an electric cleaner, an electric sprayer, an electric spreader, an electric dust extractor, a laser distance meter (or a laser distance measuring instrument), a laser level, an optical receiver of a laser level, a wall scanner, a radio, a television, a speaker, an electric cold/warm storage, an electric kettle, a coffee machine (or a coffee maker or a coffee distillation device), a microwave oven, a robotic vacuum (or a robot vacuum), a battery-powered wheel barrow, a battery-powered bicycle, a fan vest, and a heating jacket.

In one embodiment, Features 1 through 47 may be combined in any combination.

In one embodiment, any of Features 1 through 47 may be excluded.

### 2. Specific Example Embodiments

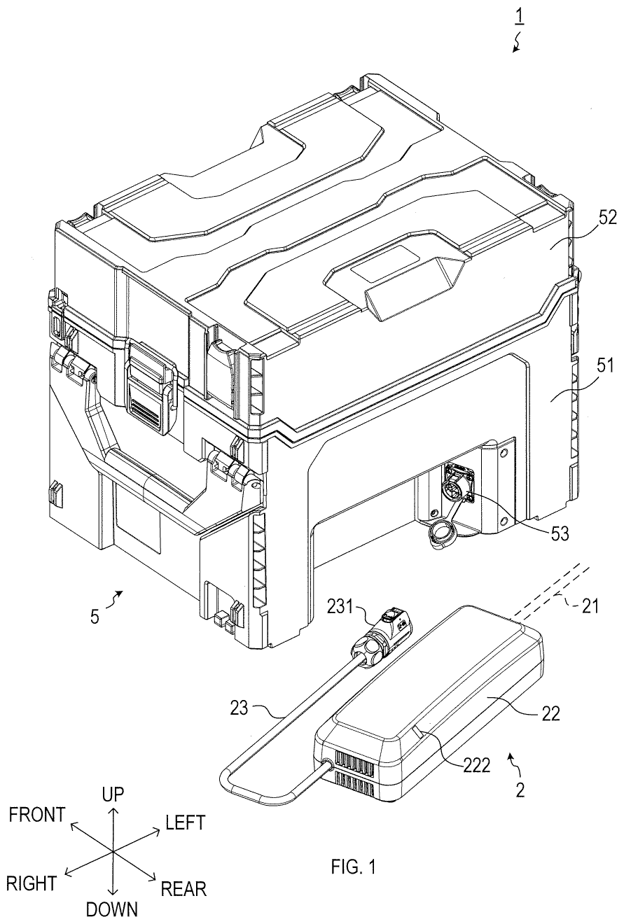

This embodiment exemplifies a charging system 1 described below. In FIGS. 1 through 3, the directions, such as “UP”, “DOWN”, “FRONT”, “REAR”, “LEFT”, and “RIGHT”, are indicated. However, these directions are merely indicated in order to facilitate better understanding of the structure of the charging system 1 and are not intended to limit the direction or the orientation of the charging system 1. The charging system 1 may be arranged in any direction or any orientation.

### 2-1. Structure of Charging System

As shown in FIG. 1, the charging system 1 includes a power-supply adapter 2. The power-supply adapter 2 is configured (i) to receive AC power Pac from a not-shown AC power supply, such as the utility power supply, and (ii) to convert the received AC power Pac into DC power Pad.

The charging system 1 includes a charger (or a charging case) 5 in the form of a box or a container. The charger 5 is configured to be detachably coupled to the power-supply adapter 2. In another embodiment, the charger 5 may be undetachable from the power-supply adapter 2.

### 2-1-1. Structure of Power-Supply Adapter

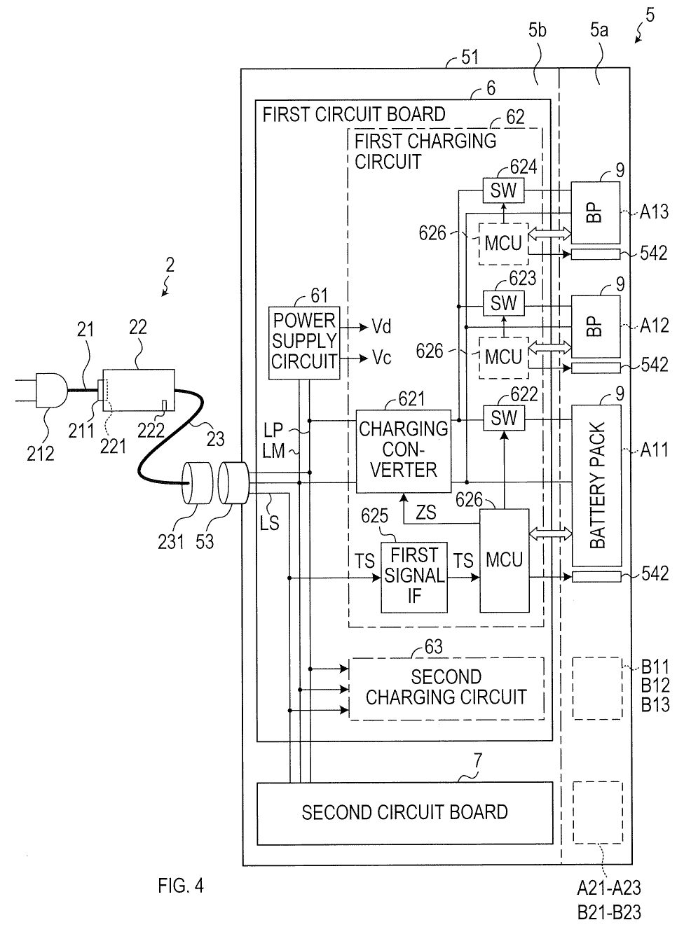

As shown in FIGS. 1 and 4, the power-supply adapter 2 includes an AC cable 21. The AC cable 21 includes a first connector 211 at a first end of the AC cable 21. The AC cable 21 includes an AC power plug 212 at a second end of the AC cable 21. The AC power plug 212 is configured (i) to be detachably coupled to the AC power supply and (ii) to receive the AC power Pac from the AC power supply.

The power-supply adapter 2 includes an adapter main body 22. The adapter main body 22 is an AC-DC converter configured (i) to receive the AC power Pac from the AC power supply via the AC cable 21, (ii) to convert the received AC power Pac into the DC power Pad, and (iii) to output the obtained DC power Pad. In this embodiment, the adapter main body 22 is, but not limited to, a switched-mode AC-DC converter.

The adapter main body 22 includes a second connector 221 configured to be detachably coupled to the first connector 211 of the AC cable 21. In FIG. 1, the AC cable 21 is detached from the adapter main body 22. In another embodiment, the AC cable 21 may be undetachable from the adapter main body 22.

The adapter main body 22 includes an adapter indicator 222 configured to indicate a state of the power-supply adapter 2. In another embodiment, the adapter indicator 222 may be excluded from the adapter main body 22.

The power-supply adapter 2 includes a DC cable 23 configured to deliver the DC power Pad output from the adapter main body 22. The DC cable 23 is undetachably coupled to the adapter main body 22 at a first end of the DC cable 23. The DC cable 23 includes a DC socket 231 at a second end of the DC cable 23. In another embodiment, the DC cable 23 may include a DC plug in place of the DC socket 231.

The DC cable 23 includes a first power line LP, a second power line LM, and a signal line LS. The first power line LP and the second power line LM are configured to deliver the DC power Pad. The signal line LS is configured to transmit an electrical signal. In another embodiment, the DC cable 23 may include an additional power line and/or an additional signal line.

### 2-1-2. Structure of Charger

As shown in FIG. 1, the charger 5 includes a charger main body (or a case body) 51. The charger main body 51 includes a DC plug 53 at the rear of the charger main body 51. The DC plug 53 is configured (i) to be detachably coupled to the DC socket 231 of the power-supply adapter 2 and (ii) to receive the DC power Pad from the DC socket 231. In another embodiment, the charger main body 51 may include the DC plug 53 at any part of the charger main body 51 other than its rear. In still another embodiment, the charger main body 51 may include a DC socket in place of the DC plug 53.

The charger 5 includes a lid body 52 configured (i) to be detachably attached to an upper part of the charger main body 51 and (ii) to close the upper part of the charger main body 51. The lid body 52 is at least partially semitransparent such that a user of the charging system 1 can visually inspect the interior of the charger main body 51. In another embodiment, the lid body 52 may be attached to the charger main body 51 via a hinge to open and close the upper part of the charger main body 51. In still another embodiment, the lid body 52 may be at least partially transparent or opaque. In still another embodiment, the lid body 52 may be excluded from the charger 5.

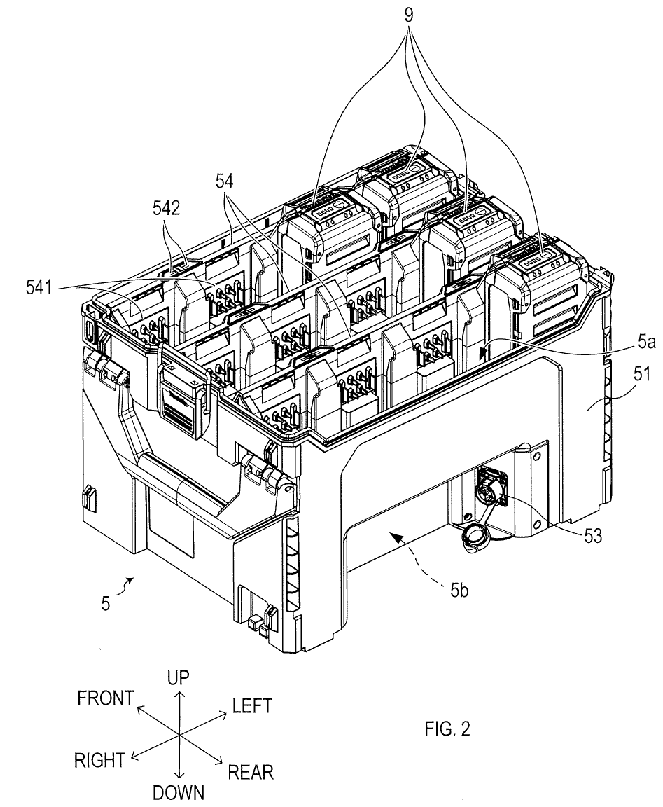

As shown in FIG. 2, the charger 5 is a multiport charger. The charger main body 51 is open at its upper part and configured to store two or more battery packs 9 therein. More specifically, the charger main body 51 includes a battery container portion 5a. The battery container portion 5a has a space capable of storing the two or more battery packs 9 (twelve battery packs 9 in this embodiment). The battery container portion 5a includes two or more tray units 54 (three tray units 54 in this embodiment). Each battery pack 9 includes one or more rechargeable battery cells (not shown) and is configured to be detachably attached to various electric-powered work machines. Each battery pack 9 will be stored in the battery container portion 5a with the battery pack 9 attached to one of the tray units 54.

Each tray unit 54 includes two or more attachments 541 (four attachments 541 in this embodiment). Each attachment 541 is configured such that one of the two or more battery packs 9 is detachably attached thereto.

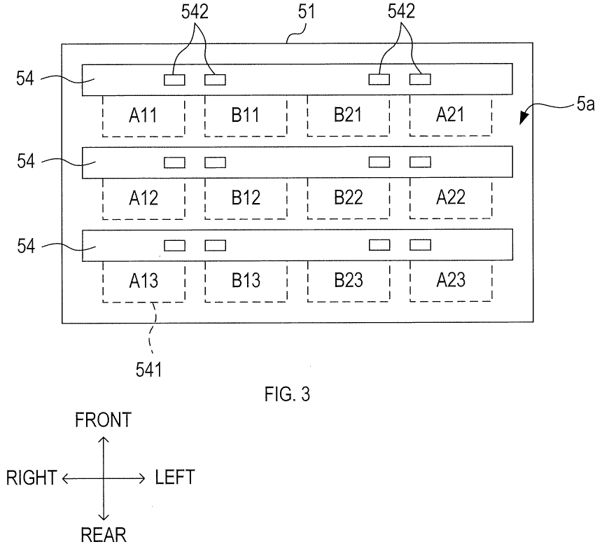

In this embodiment, as shown in FIG. 3, the two or more attachments 541 are referred to as attachments A11, A12, A13, B11, B12, B13, A21, A22, A23, B21, B22, and B23, respectively, for their identification.

Each tray unit 54 includes two or more charging indicators 542 (four charging indicators 542 in this embodiment) respectively associated with the two or more attachments 541 on the tray unit 54. Each charging indicator 542 is arranged on a corresponding tray unit 54 such that the user can visually check the charging indicator 542 with the lid body 52 attached to or detached from the charger main body 51. In addition, each charging indicator 542 is arranged adjacent to a corresponding attachment 541 such that the user can easily identify the corresponding attachment 541.

Each charging indicator 542 is configured to indicate a state of the battery pack 9 attached to a corresponding attachment 541. Each charging indicator 542 includes a not-shown light emitting diode (LED). Examples of the states of the battery pack 9 to be indicated by each charging indicator 542 include (i) a state in which the battery pack 9 is being charged, (ii) a state in which the charging of the battery pack 9 has been completed, and (iii) a state in which the battery pack 9 is anomalous (or failed). In another embodiment, each charging indicator 542 may include a liquid crystal display (LCD) in addition to or in place of the LED.

Referring back to FIG. 2, the charger main body 51 includes a board container portion 5b below the battery container portion 5a. The board container portion 5b stores therein two or more circuit boards described below. In another embodiment, the board container portion 5b may store a single circuit board therein.

### 2-2. Circuit Configuration of Charging System

### 2-2-1. Circuit Configuration of Charger

The charger 5 includes a circuit configuration configured to sequentially or simultaneously charge the one or more battery packs 9 stored in the battery container portion 5a.

Specifically, as shown in FIG. 4, the charger 5 includes a first circuit board 6 and a second circuit board 7 in the board container portion 5b. In another embodiment, the first circuit board 6 and/or the second circuit board 7 may be provided to any part of the charger 5 other than in the board container portion 5b. In still another embodiment, either the first circuit board 6 or the second circuit board 7 may be excluded from the charger 5.

The first circuit board 6 includes thereon the first power line LP, the second power line LM, and the signal line LS, all of which are coupled to the DC plug 53. The first power line LP, the second power line LM, and the signal line LS on the first circuit board 6 are respectively coupled to the first power line LP, the second power line LM, and the signal line LS in the DC cable 23 when the DC plug 53 is coupled to the DC socket 231 of the power-supply adapter 2. Thus, the first circuit board 6 is configured to receive the DC power Pad and the electrical signal from the power-supply adapter 2 via the DC plug 53. The first power line LP, the second power line LM, and the signal line LS on the first circuit board 6 are, but not limited to, printed wirings (or traces or conductive tracks). In another embodiment, the first circuit board 6 may include an additional power line and/or an additional signal line.

The first circuit board 6 includes a power supply circuit 61, a first charging circuit 62, and a second charging circuit 63. In another embodiment, the power supply circuit 61, the first charging circuit 62, or the second charging circuit 63 may be excluded from the first circuit board 6.

The power supply circuit 61 is a DC-DC converter (i) including a pair of input terminals respectively coupled to the first power line LP and the second power line LM on the first circuit board 6, and (ii) configured to generate a first power-supply voltage Vd (e.g., DC 5 volts) and a second power-supply voltage Vc (e.g., DC 15 volts) based on the DC power Pad received from the power-supply adapter 2 via the DC plug 53. The first power-supply voltage Vd is delivered to a low voltage circuit on the first circuit board 6. The second power-supply voltage Vc is delivered to a high voltage circuit on the first circuit board 6. In another embodiment, the power supply circuit 61 may be configured not to generate both the first power-supply voltage Vd and the second power-supply voltage Vc but to generate either the first power-supply voltage Vd or the second power-supply voltage Vc.

The first charging circuit 62 is configured to charge the battery packs (BP) 9 attached to the attachments All through A13.

More specifically, the first charging circuit 62 includes a charging converter 621, first through third switches (SWs) 622 through 624, a first signal interface (IF) 625, and a main control unit (MCU) 626. In another embodiment, any one or more of the charging converter 621, the first through third SWs 622 through 624, the first signal IF 625, and the MCU 626 may be excluded from the first charging circuit 62.

The charging converter 621 is a DC-DC converter including (i) a first input terminal coupled to the first power line LP on the first circuit board 6, (ii) a second input terminal coupled to the second power line LM on the first circuit board 6, (iii) a first output terminal configured to be coupled to positive electrodes of the battery packs 9 through the attachments A11 through A13, (iv) a second output terminal configured to be coupled to negative electrodes of the battery packs 9 via the attachments A11 through A13, and (v) a signal terminal coupled to the MCU 626. The charging converter 621 is configured (i) to receive the DC power Pad at its first and second input terminals and (ii) to deliver a charging current Ich through its first and second output terminals to the battery packs 9 attached to the attachments A11 through A13. The charging converter 621 is also configured to vary the magnitude of the charging current Ich, and thus, the charging power Pch in accordance with a logic level of a charging power limiting signal ZS received at its signal terminal. The charging power limiting signal ZS is a digital signal. More specifically, the charging power limiting signal ZS is a negative logic signal (or an active low signal). In another embodiment, the charging power limiting signal ZS may be a positive logic signal (or an active high signal).

The first SW 622 is configured to be controlled by the MCU 626 so as to complete or interrupt a current path between the first output terminal of the charging converter 621 and the positive electrode of the battery pack 9 attached to the attachment A11.

The second SW 623 is configured to be controlled by the MCU 626 so as to complete or interrupt a current path between the first output terminal of the charging converter 621 and the positive electrode of the battery pack 9 attached to the attachment A12.

The third SW 624 is configured to be controlled by the MCU 626 so as to complete or interrupt a current path between the first output terminal of the charging converter 621 and the positive electrode of the battery pack 9 attached to the attachment A13.

The first through third SWs 622 through 624 include metal-oxide-semiconductor field-effect transistors (MOSFETs). In another embodiment, at least one of the first through third SWs 622 through 624 may include, in place of or in addition to the MOSFET, another typed semiconductor switch (e.g., a junction field-effect transistor (JFET) or a metal-semiconductor field-effect transistor (MESFET)) and/or a mechanical relay.

The first signal IF 625 includes (i) an input terminal coupled to the signal line LS on the first circuit board 6 and (ii) an output terminal coupled to the MCU 626. The first signal IF 625 is configured (i) to reshape a waveform of a state indicating signal TS received at its input terminal and (ii) to deliver the reshaped state indicating signal TS to the MCU 626. With the reshaped state indicating signal TS, the MCU 626 can correctly determine whether the state indicating signal TS is asserted. The state indicating signal TS is a digital signal. More specifically, the state indicating signal TS is a positive logic signal (or an active high signal). In another embodiment, the state indicating signal TS may be a negative logic signal (or an active low signal).

The MCU 626 is coupled to the charging converter 621, to the first signal IF 625, to the first through third SWs 622 through 624, and to the charging indicators 542 corresponding to the attachments A11 through A13. The MCU 626 is a single control unit, but is divided into (i) one block of solid line and (ii) two blocks of broken line in FIG. 4 for ease of illustration.

The MCU 626 is configured (i) to be coupled to the battery packs 9 attached to the attachments A11 through A13 and (ii) to communicate individually with these battery packs 9. The MCU 626 includes a not-shown microcomputer (or a microcontroller or a microprocessor) and is configured (or programmed) to execute at least a charging control process and a charging limitation process.

In the charging control process, the MCU 626 obtains information from each of the battery packs 9 attached to the attachments A11 through A13. The information obtained from each of the battery packs 9 indicates at least a state of a corresponding battery pack 9 (e.g., its charged state). In addition, the MCU 626 individually controls the first through third SWs 622 through 624 in accordance with the information obtained from each of the battery packs 9. The MCU 626 also indicates, in accordance with the information obtained from each of the battery packs 9, a state of the corresponding battery pack 9 on the charging indicator 542 associated with the corresponding attachment 541.

In the charging limitation process, the MCU 626 generates the charging power limiting signal ZS based on the state indicating signal TS received from the first signal IF 625. Specifically, the MCU 626 (i) asserts the charging power limiting signal ZS in response to an elapse of the later-described first waiting time after the received state indicating signal TS is asserted and (ii) negates the charging power limiting signal ZS in response to the elapse of the first waiting time after the received state indicating signal TS is negated. The charging converter 621 is configured (i) to set a target value (or a desired value) of the charging current Ich to a first target value (e.g., 1.6 amperes) in response to the charging power limiting signal ZS being negated, and (ii) to set the target value of the charging current Ich to a second target value (e.g., 0.6 amperes) in response to the charging power limiting signal ZS being asserted. The second target value is smaller than the first target value. Accordingly, in response to the decrease in the target value of the charging current Ich from the first target value to the second target value, the charging power Pch in the charger 5 can be decreased.

In another embodiment, the MCU 626 may include an additional microcomputer. In still another embodiment, the MCU 626 may include, in addition to or in place of the microcomputer, a logic circuit (or a wired logic connection) including two or more electronic components. In still another embodiment, the MCU 626 may include, in addition to or in place of the microcomputer, a graphics processing unit (GPU), an application-specific integrated circuit (ASIC), an application-specific standard product (ASSP) and/or a programmable logic device (PLD), such as a field-programmable gate array (FPGA). In still another embodiment, MCU 626 may be, in place of the single control unit, a combination of two or more control units. More specifically, the MCU 626 may be a combination of three dedicated control units respectively associated with the attachments A11 through A13. Each of these dedicated control units may be configured (i) to communicate with a corresponding battery pack 9 and (ii) to control a corresponding one of the first through third SWs 622 through 624. The charging limitation process may be executed by all of or at least one of these dedicated control units.

The second charging circuit 63 is configured to charge the battery packs 9 attached to the attachments B11 through B13. The second charging circuit 63 is configured in the same manner as the first charging circuit 62. Therefore, a detailed description of the second charging circuit 63 is omitted.

The second circuit board 7 is configured to charge the battery packs 9 attached to the attachments A21 through A23 and B21 through B23. The second circuit board 7 is configured in the same manner as the first circuit board 6, except that the second circuit board 7 receives the DC power Pad and the state indicating signal TS via the first circuit board 6. Therefore, a detailed description of the second circuit board 7 is omitted.

### 2-2-2. Circuit Configuration of Power-Supply Adapter

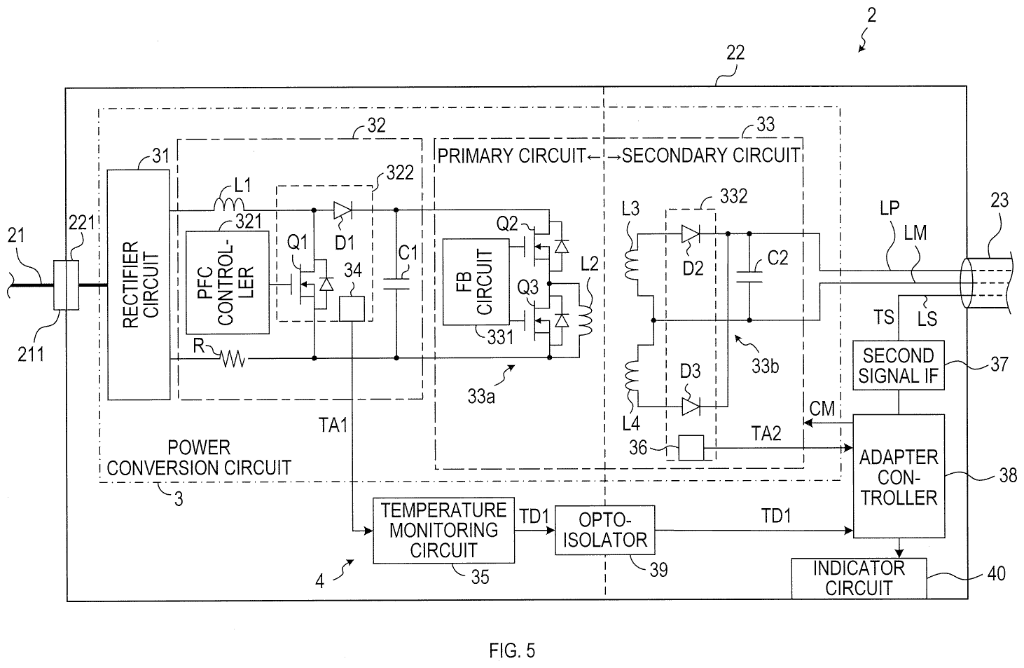

As shown in FIG. 5, the power-supply adapter 2 includes a power conversion circuit 3, a state detection circuit 4, and an indicator circuit 40 in the adapter main body 22. In another embodiment, the indicator circuit 40 may be excluded from the adapter main body 22.

The power conversion circuit 3 is configured (i) to receive the AC power Pac from the AC cable 21 via the second connector 221, (ii) to convert the received AC power Pac into the DC power Pad, and (iii) to output the obtained DC power Pad to the DC cable 23.

More specifically, the power conversion circuit 3 includes a rectifier circuit 31, a power factor correction (PFC) circuit 32, and a main converter 33. In another embodiment, the PFC circuit 32 may be excluded from the power conversion circuit 3.

The rectifier circuit 31 is coupled to the second connector 221. The rectifier circuit 31 is configured (i) to receive an AC current Iac from the second connector 221, (ii) to perform a full-wave rectification on the received AC current Iac, and (iii) to output the rectified AC current Iac from a positive-side output terminal of the rectifier circuit 31. The rectifier circuit 31 may include a diode bridge. In another embodiment, the rectifier circuit 31 may be configured to perform a half-wave rectification on the AC current Iac received from the second connector 221.

The PFC circuit 32 is configured (i) to receive the rectified AC current Iac from the rectifier circuit 31 and (ii) to improve a power factor (i.e., a ratio of a real power to an apparent power) of the power-supply adapter 2. The PFC circuit 32 is an active (or switched-mode) PFC circuit. In another embodiment, the PFC circuit 32 may be a passive (or static) PFC circuit.

More specifically, the PFC circuit 32 includes an inductor L1, a first diode D1, a first capacitor C1, a resistor R, a first semiconductor switch Q1, and a PFC controller 321.

The inductor L1 includes (i) a first end coupled to the positive-side output terminal of the rectifier circuit 31 and (ii) a second end coupled to an anode of the first diode D1. The first diode D1 includes a cathode coupled to a first terminal of the first capacitor C1. The resistor R includes (i) a first end coupled to a negative-side output terminal of the rectifier circuit 31 and (ii) a second end coupled to a second terminal of the first capacitor C1. The first semiconductor switch Q1 is configured to complete or interrupt a current path between the second end of the inductor L1 and the second end of the resistor R. The first semiconductor switch Q1 is, but not limited to, a MOSFET.

The PFC controller 321 is configured to control a switching operation of the first semiconductor switch Q1 so as to reshape a waveform of the rectified AC current Iac for improving the power factor. The PFC controller 321 is, but not limited to, an ASIC.

The PFC circuit 32 is provided with a first heat dissipation plate (or a first heat sink) 322. The first heat dissipation plate 322 is an insulated metal member and is arranged so as to dissipate heat generated in the first diode D1 and the first semiconductor switch Q1.

The main converter 33 is a half-bridge DC-DC converter configured (i) to receive an output of the PFC circuit 32 and (ii) to generate the DC power Pad to be delivered to the charger 5. In another embodiment, the main converter 33 may be a DC-DC converter other than the half-bridge type.

Specifically, the main converter 33 includes a primary circuit 33a and a secondary circuit 33b.

The primary circuit 33a includes second and third semiconductor switches Q2 and Q3, a first winding L2, and a feedback (FB) circuit 331.

The second and third semiconductor switches Q2 and Q3 are coupled in series with each other and configured to complete or interrupt a current path between the first and second terminals of the first capacitor C1. Each of the second and third semiconductor switches Q2 and Q3 is, but not limited to, a MOSFET. The first winding L2 is coupled in parallel with the third semiconductor switch Q3. The FB circuit 331 is configured to control switching operations of the second and third semiconductor switches Q2 and Q3. The FB circuit 331 is, but not limited to, an ASIC.

The secondary circuit 33b includes second and third windings L3 and L4, second and third diodes D2 and D3, and a second capacitor C2. In another embodiment, a combination of the second winding L3 with the second diode D2 or a combination of the third winding L4 with the third diode D3 may be excluded from the secondary circuit 33b.

The second winding L3 includes (i) a first end coupled to an anode of the second diode D2 and (ii) a second end coupled to a first end of the third winding L4. The third winding L4 includes a second end coupled to an anode of the third diode D3. The second and third diodes D2 and D3 include their respective cathodes coupled with each other. In other words, the second and third diodes D2 and D3 are provided on the secondary circuit 33b so as to rectify an induced current lind generated in the second and third windings L3 and L4.

The second capacitor C2 includes (i) a first terminal coupled to the cathodes of the second and third diode D2 and D3 and (ii) a second terminal coupled to the second end of the second winding L3 and to the first end of the third winding L4. The first and second terminals of the second capacitor C2 are respectively coupled to the first power line LP and the second power line LM. Accordingly, the induced current Iind charges the second capacitor C2 and the DC power Pad charged in the second capacitor C2 is delivered to the DC cable 23 as an output of the main converter 33.

The second and third windings L3 and L4 are not electrically coupled to the first winding L2, but are arranged to be inductively (or electromagnetically) coupled thereto. That is, the second and third windings L3 and L4 together with the first winding L2 form an isolation transformer. Thus, the power conversion circuit 3 is configured to provide a galvanic isolation between its AC input and its DC output. In other words, the secondary circuit 33b is isolated from the second connector 221, the rectifier circuit 31, PFC circuit 32, and the primary circuit 33a. The power conversion circuit 3, the state detection circuit 4, and the indicator circuit 40 are protected and insulated by a housing of the adapter main body 22. Accordingly, in another embodiment, the first through third windings L2 through L4 may form a non-isolation transformer, such as an autotransformer.

The FB circuit 331 is configured to control the switching operations of the second and third semiconductor switches Q2 and Q3 such that (i) an output voltage Vad from the secondary circuit 33b (i.e., the second capacitor C2) has a prespecified value (e.g., DC 48 volts) and (ii) an output current Iad from the secondary circuit 33b (i.e., the second capacitor C2) does not exceed its upper limit. Specifically, the upper limit of the output current Iad is set either to (i) a first upper limit value (e.g., 6 amperes) or (ii) a second upper limit value (e.g., 2 amperes) in accordance with a logic level of a supply limiting signal CM to be output from the state detection circuit 4 to the main converter 33. The second upper limit value is lower than the first upper limit value. The supply limiting signal CM is a digital signal. More specifically, the supply limiting signal CM is a negative logic signal (or an active low signal). In another embodiment, the supply limiting signal CM may be a positive logic signal (or an active high signal).

When the first upper limit value is 6 amperes, the power-supply adapter 2 can deliver, to the charger 5, the DC power Pad of approximately 300 watts (≡48 volts×6 amperes) at the maximum. On the other hand, when the second upper limit value is 2 amperes, the DC power Pad delivered from the power-supply adapter 2 to the charger 5 is limited to approximately 100 watts (≡48 volts×2 ampere) at the maximum. Hereinafter, a state of the main converter 33 in which the upper limit of the output current Iad is set to the first upper limit value is referred to as a “non-limited operating state”, and a state of the main converter 33 in which the upper limit of the output current Iad is set to the second upper limit value is referred to as a “limited operating state”.

The main converter 33 is provided with a second heat dissipation plate (or a second heat sink) 332. The second heat dissipation plate 332 is an insulated metal member and is arranged to dissipate heat generated in the second diode D2 and the third diode D3.

The state detection circuit 4 is configured (i) to generate the state indicating signal TS, (ii) to transmit the generated state indicating signal TS to the DC cable 23, and (iii) to vary the state indicating signal TS and an operation of the power conversion circuit 3 in accordance with the state of the power-supply adapter 2. Specifically, the state detection circuit 4 is configured to vary the state indicating signal TS and the operation of the power conversion circuit 3 in accordance with a temperature of the first heat dissipation plate 322 and/or a temperature of the second heat dissipation plate 332. In another embodiment, the state detection circuit 4 may be configured not to vary both the state indicating signal TS and the operation of the power conversion circuit 3 but to vary either the state indicating signal TS or the operation of the power conversion circuit 3. In still another embodiment, the state detection circuit 4 may be configured to vary the state indicating signal TS and/or the operation of the power conversion circuit 3 in accordance with the state of the power-supply adapter 2 other than the temperature of the first heat dissipation plate 322 and the temperature of the second heat dissipation plate 332.

More specifically, the state detection circuit 4 includes a first temperature sensor 34, a temperature monitoring circuit 35, a second temperature sensor 36, a second signal IF 37, an adapter controller 38, and an optoisolator 39. In another embodiment, a combination of the first temperature sensor 34, the temperature monitoring circuit 35, and the optoisolator 39 may be excluded from the state detection circuit 4. In still another embodiment, the second signal IF 37 and/or the optoisolator 39 may be excluded from the state detection circuit 4. In still another embodiment, the second temperature sensor 36 may be excluded from the state detection circuit 4. In still another embodiment, the state detection circuit 4 may include, in addition to or in place of the first temperature sensor 34 and/or the second temperature sensor 36, (i) a current detector configured to detect a magnitude of an electric current flowing through any part on the power conversion circuit 3 and/or (ii) a voltage detector configured to detect a voltage at any part on the power conversion circuit 3. In this case, the state detection circuit 4 may be configured to vary the state indicating signal TS and/or the operation of the power conversion circuit 3 in accordance with (i) the magnitude of the electric current detected by the current detector and/or (ii) the voltage detected by the voltage detector.

The first temperature sensor 34 is arranged in the vicinity of the first semiconductor switch Q1 on the first heat dissipation plate 322. The first temperature sensor 34 is configured to output a first temperature signal TA1 that is varied in accordance with the temperature of the first heat dissipation plate 322, and thus, a temperature of the first semiconductor switch Q1 and/or a temperature of the first diode D1. The first temperature signal TA1 is an analog signal. In another embodiment, the first temperature sensor 34 may be positioned anywhere on the first heat dissipation plate 322 other than in the vicinity of the first semiconductor switch Q1.

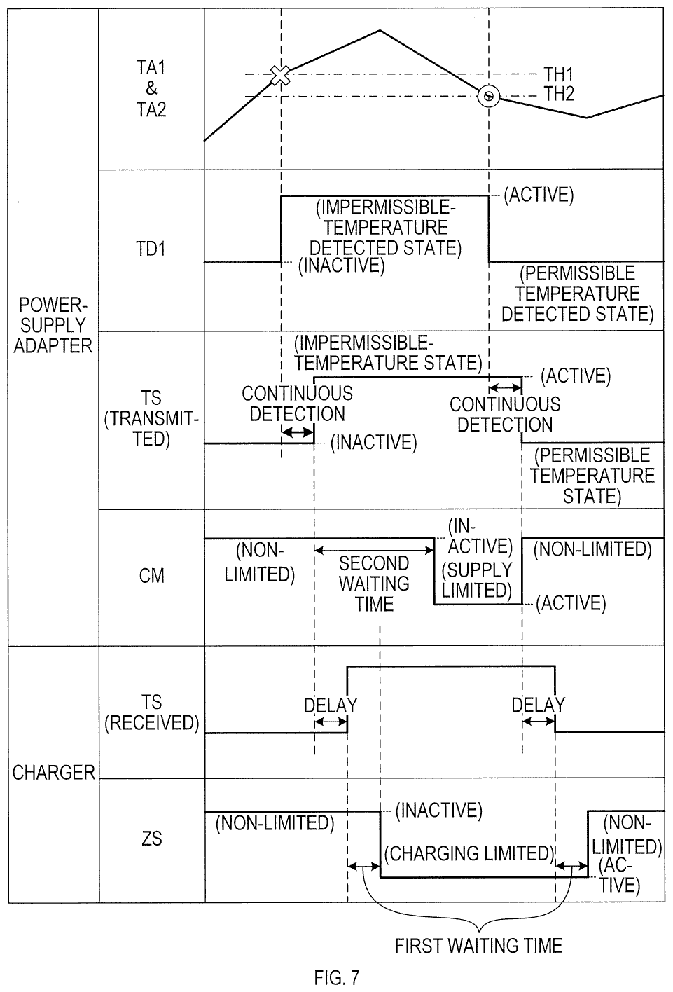

The temperature monitoring circuit 35 is configured (i) to receive the first temperature signal TA1 from the first temperature sensor 34 and (ii) to generate an impermissible-temperature detection signal TD1 from the received first temperature signal TA1. The impermissible-temperature detection signal TD1 is a digital signal. Specifically, as shown in FIG. 7, the impermissible-temperature detection signal TD1 is a positive logic signal (or an active high signal). The temperature monitoring circuit 35 is configured to have a hysteresis with respect to the first temperature signal TA1. Accordingly, the temperature monitoring circuit 35 is configured to assert the impermissible-temperature detection signal TD1 in response to a voltage of the first temperature signal TA1 having varied from a voltage lower than an impermissible-temperature detection threshold TH1 to a voltage higher than the impermissible-temperature detection threshold TH1. The temperature monitoring circuit 35 is also configured to negate the impermissible-temperature detection signal TD1 in response to the voltage of the first temperature signal TA1 having varied from a voltage higher than an impermissible-temperature cancellation threshold TH2 to a voltage lower than the impermissible-temperature cancellation threshold TH2. The impermissible-temperature cancellation threshold TH2 is lower than the impermissible-temperature detection threshold TH1. More specifically, the impermissible-temperature detection threshold TH1 corresponds to a temperature at which the probability that the power-supply adapter 2 will cause a malfunction due to heat generation is higher than or equal to a permissible value. The impermissible-temperature cancellation threshold TH2 corresponds to a temperature at which the probability that the power-supply adapter 2 will cause a malfunction due to heat generation is significantly lower than the permissible value. In another embodiment, the temperature monitoring circuit 35 may have no hysteresis with respect to the first temperature signal TA1. In still another embodiment, the impermissible-temperature detection signal TD1 may be a negative logic signal (or an active low signal). In still another embodiment, the temperature monitoring circuit 35 may have either the impermissible-temperature detection threshold TH1 or the impermissible-temperature cancellation threshold TH2.

Referring back to FIG. 5, the optoisolator 39 is an optocoupler (or a photocoupler) configured to optically couple the temperature monitoring circuit 35 with the adapter controller 38 so as to transmit the impermissible-temperature detection signal TD1 from the temperature monitoring circuit 35 to the adapter controller 38. With the optoisolator 39, not only the adapter controller 38 but also the second temperature sensor 36, the second signal IF 37, and the indicator circuit 40 are isolated from the first temperature sensor 34 and the temperature monitoring circuit 35. In another embodiment, the optoisolator 39 may be an opto-emulator or an SSR, in place of the optocoupler.

The second temperature sensor 36 is arranged in the vicinity of the third diode D3 on the second heat dissipation plate 332. The second temperature sensor 36 is configured to output a second temperature signal TA2 that is varied in accordance with the temperature of the second heat dissipation plate 332, and thus, a temperature of the third diode D3 and/or a temperature of the second diode D2. The second temperature signal TA2 is an analog signal. In another embodiment, the second temperature sensor 36 may be positioned anywhere on the second heat dissipation plate 332 other than in the vicinity of the third diode D3 (e.g., in the vicinity of the second diode D2).

The adapter controller 38 is configured (i) to receive the impermissible-temperature detection signal TD1 from the optoisolator 39, (ii) to receive the second temperature signal TA2 from the second temperature sensor 36, (iii) to output the supply limiting signal CM to the main converter 33, (iv) to output the state indicating signal TS to the second signal IF 37, and (v) to control the indicator circuit 40.

The adapter controller 38 includes a not-shown microcomputer and is configured (or programmed) to execute at least a temperature control process. The temperature control process is a process for controlling the main converter 33, the charging converter 621 and the indicator circuit 40 based on the impermissible-temperature detection signal TD1 and the second temperature signal TA2. The adapter controller 38 is also configured to convert a voltage of the second temperature signal TA2 into a digital value. The adapter controller 38 is also configured (i) to set an impermissible-temperature state flag F1 when a temperature of the power-supply adapter 2 (more specifically, the adapter main body 22) is impermissible and (ii) to clear the impermissible-temperature state flag F1 when the temperature of the power-supply adapter 2 is permissible. The temperature impermissible for the power-supply adapter 2 is a temperature corresponding to the impermissible-temperature detection threshold TH1. The adapter controller 38 is configured to have a hysteresis with respect to the second temperature signal TA2. Specifically, the adapter controller 38 is configured to set an impermissible-temperature detection flag F2 in response to (i) the impermissible-temperature detection signal TD1 being asserted or (ii) the digital value of the second temperature signal TA2 having varied from a value lower than the impermissible-temperature detection threshold TH1 to a value higher than the impermissible-temperature detection threshold TH1. The adapter controller 38 is also configured to clear the impermissible-temperature detection flag F2 in response to (i) the impermissible-temperature detection signal TD1 being negated and (ii) the digital value of the second temperature signal TA2 having varied from a value higher than the impermissible-temperature cancellation threshold TH2 to a value lower than the impermissible-temperature cancellation threshold TH2.

In another embodiment, the adapter controller 38 may include an additional microcomputer. In still another embodiment, the adapter controller 38 may include, in addition to or in place of the microcomputer, a logic circuit (or a wired logic connection) including two or more electronic components. In still another embodiment, the adapter controller 38 may include, in addition to or in place of the microcomputer, a GPU, an ASIC, an ASSP and/or a PLD.

The second signal IF 37 is configured (i) to amplify the state indicating signal TS received from the adapter controller 38 and (ii) to output the amplified state indicating signal TS to the signal line LS.

The indicator circuit 40 includes a not-shown LED and is configured to indicate the state of the power-supply adapter 2 on the adapter indicator 222 in accordance with a command received from the adapter controller 38. Examples of the states of the power-supply adapter 2 include (i) a state in which the power-supply adapter 2 is receiving the AC power Pac, (ii) a state in which the power-supply adapter 2 is not receiving the AC power Pac, (iii) a state in which the temperature of the power-supply adapter 2 is permissible, and (iv) a state in which the temperature of the power-supply adapter 2 is impermissible. The indicator circuit 40 is configured (i) to turn on the LED in response to the temperature of the power-supply adapter 2 being permissible, (ii) to blink the LED in response to the temperature of the power-supply adapter 2 being impermissible, (iii) to turn off the LED in response to the power-supply adapter 2 not receiving the AC power Pac. In another embodiment, the indicator circuit 40 may include, in addition to or in place of the LED, an LCD. In still another embodiment, the indicator circuit 40 may be configured to vary the emission colors of the LED or the LCD in accordance with the state of the power-supply adapter 2.

In another embodiment, the adapter main body 22 may include (i) a cooling fan configured to cool an electronic circuit built in the adapter main body 22, (ii) an additional electronic circuit configured to monitor an operating state of the cooling fan, and/or (iii) a further additional electronic circuit configured to detect a coupling of the adapter main body 22 to the charger 5 via the DC cable 23.

### 2-3. Details of Temperature Control Process

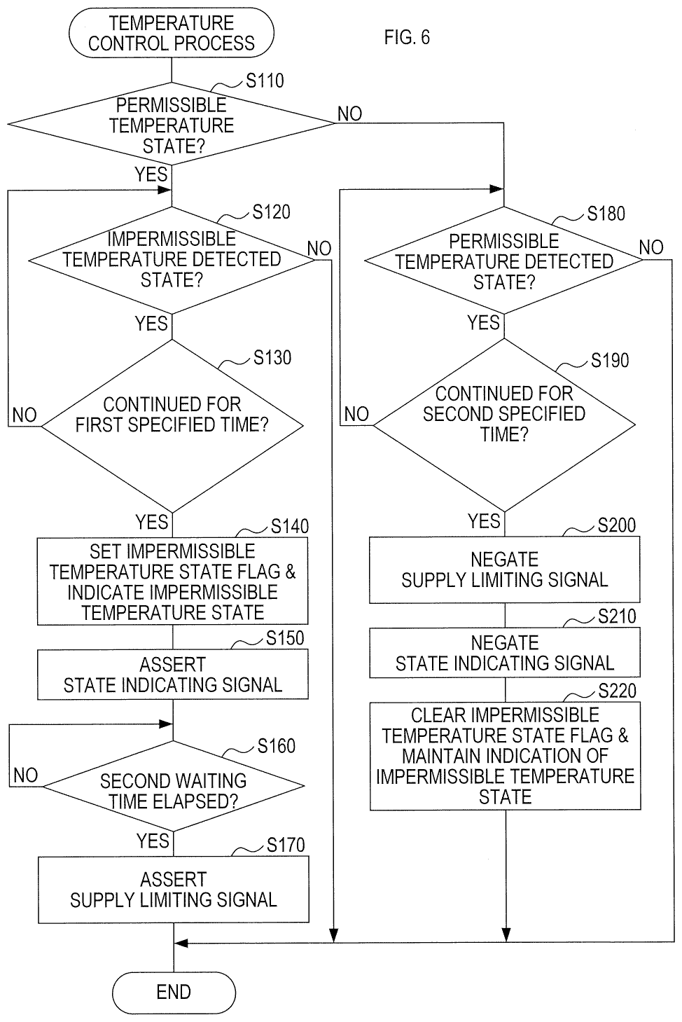

With reference to FIG. 6, the temperature control process executed by the adapter controller 38 is described. The temperature control process is repeatedly executed while the adapter main body 22 is coupled (i) to the AC power supply via the AC cable 21 and (ii) to the charger 5 via the DC cable 23.

Upon the activation of the adapter controller 38, the logic level of the state indicating signal TS, the logic level of the supply limiting signal CM, the impermissible-temperature state the flag F1, and impermissible-temperature detection flag F2 are initialized. Specifically, the state indicating signal TS and the supply limiting signal CM are negated, and the impermissible-temperature state flag F1 and the impermissible-temperature detection flag F2 are cleared.

When the temperature control process is started, the adapter controller 38 determines in S110 whether the impermissible-temperature state flag F1 is cleared, in other words, whether the power-supply adapter 2 is in a permissible temperature state where the temperature of the power-supply adapter 2 is permissible. If the impermissible-temperature state flag F1 is cleared (S110: YES), the adapter controller 38 proceeds to S120. If the impermissible-temperature state flag F1 is set (S110: NO), the adapter controller 38 proceeds to S180.

In S120, the adapter controller 38 determines whether the impermissible-temperature detection flag F2 is set, in other words, whether the power-supply adapter 2 is in an impermissible-temperature detected state where the adapter controller 38 has detected that the temperature of the power-supply adapter 2 is impermissible. If the impermissible-temperature detection flag F2 is set (S120: YES), the adapter controller 38 proceeds to S130. If the impermissible-temperature detection flag F2 is cleared (S120: NO), the adapter controller 38 immediately terminates the temperature control process.

In S130, the adapter controller 38 determines whether the impermissible-temperature detection flag F2 has been set for a first specified time (e.g., four seconds) or longer. The first specified time is set in order to ignore an event where the impermissible-temperature detection flag F2 is erroneously set due to an electrical noise. If the impermissible-temperature detection flag F2 has not been set for the first specified time or longer (S130: NO), the adapter controller 38 returns to S120. If the impermissible-temperature detection flag F2 has been set for the first specified time or longer (S130: YES), the adapter controller 38 proceeds to S140.

In S140, the adapter controller 38 sets the impermissible-temperature state flag F1 and sends, to the indicator circuit 40, a command to indicate that the temperature of the power-supply adapter 2 is impermissible.

In the subsequent S150, the adapter controller 38 asserts the state indicating signal TS.

In the subsequent S160, the adapter controller 38 determines whether a later-described second waiting time has elapsed after asserting the state indicating signal TS.

If the second waiting time has not elapsed (S160: NO), the adapter controller 38 repeats a process of S160. If the second waiting time has elapsed (S160: YES), the adapter controller 38 proceeds to S170.

In S170, the adapter controller 38 asserts the supply limiting signal CM and terminates the temperature control process. Accordingly, the main converter 33 transitions to the limited operating state.

In S180, the adapter controller 38 determines whether the impermissible-temperature detection flag F2 is cleared, in other words, whether the power-supply adapter 2 is in a permissible-temperature detected state where the adapter controller 38 detects that the temperature of the power-supply adapter 2 is permissible. If the impermissible-temperature detection flag F2 is cleared (S180: YES), the adapter controller 38 proceeds to S190. If the impermissible-temperature detection flag F2 is set (S180: NO), the adapter controller 38 immediately terminates the temperature control process.

In S190, the adapter controller 38 determines whether the impermissible-temperature detection flag F2 has been cleared for a second specified time (e.g., four seconds) or longer. The second specified time is set in order to ignore an event where the impermissible-temperature detection flag F2 is erroneously cleared due to an electrical noise.

If the impermissible-temperature detection flag F2 has not been cleared for the second specified time or longer (S190: NO), the adapter controller 38 returns to S180. If the impermissible-temperature detection flag F2 has been cleared for the second specified time or longer (S190: YES), the adapter controller 38 proceeds to S200.

In S200, the adapter controller 38 negates the supply limiting signal CM. Accordingly, the main converter 33 transitions to the non-limited operating state.

In the subsequent S210, the adapter controller 38 negates the state indicating signal TS.

In the subsequent S220, the adapter controller 38 (i) clears the impermissible-temperature state flag F1, (ii) sends, to the indicator circuit 40, a command to maintain the indication that the temperature of the power-supply adapter 2 is impermissible, and (iii) terminates the temperature control process. The indication is maintained until the adapter main body 22 is decoupled from the AC power supply or the charger 5.

### 2-4. Overview of Operation of Charging System

One example of the operations of the charging system 1 is described hereinafter.

As shown in FIG. 7, when the voltage of the first temperature signal TA1 has varied from a voltage lower than the impermissible-temperature detection threshold TH1 to than the a voltage higher impermissible-temperature detection threshold TH1, the impermissible-temperature detection signal TD1 is asserted by the temperature monitoring circuit 35.

The adapter controller 38 determines whether the power-supply adapter 2 is in the impermissible-temperature detected state, based on the logic level of the impermissible-temperature detection signal TD1 and the digital value of the second temperature signal TA2. In response to the power-supply adapter 2 having been detected in the impermissible-temperature detected state for the first specified time or longer, the adapter controller 38 asserts the state indicating signal TS.

The variation in the state indicating signal TS is transmitted to the MCU 626 with some delay due to the influences made by the second signal IF 37, the DC cable 23, and the first signal IF 625 (e.g., due to their parasitic inductances). Subsequently, the MCU 626 waits for the first waiting time to elapse. The first waiting time is set longer than or equal to a time required for the output current Iad to be returned to the first upper limit value after the supply limiting signal CM is negated.

Upon the elapse of the first waiting time, the MCU 626 asserts the charging power limiting signal ZS. Accordingly, the target value of the charging current Ich in the charging converter 621 is decreased from the first target value to the second target value. As a result, the charging power Pch in the charger 5 decreases.

After asserting the state indicating signal TS, the adapter controller 38 waits for the second waiting time to elapse. The second waiting time is set longer than or equal to a time required for the charging converter 621 to decrease the target value of the charging current Ich from the first target value to the second target value after the adapter controller 38 asserts the state indicating signal TS. In other words, the adapter controller 38 waits for the charging power Pch in the charger 5 to decrease.

Upon the elapse of the second waiting time, the adapter controller 38 asserts the supply limiting signal CM. The main converter 33 limits, to the second upper limit value, the upper limit of the output current Iad from the main converter 33. Accordingly, the heat being generated in the power conversion circuit 3 decreases.

Subsequently, the adapter controller 38 determines whether the power-supply adapter 2 is in the permissible-temperature detected state, based on the logic level of the impermissible-temperature detection signal TD1 and the digital value of the second temperature signal TA2. In response to the power-supply adapter 2 having been detected in the permissible-temperature detected state for the second specified time or longer, the adapter controller 38 negates the state indicating signal TS and the supply limiting signal CM.

In response to the supply limiting signal CM being negated, the main converter 33 restores the upper limit of the output current Iad from the main converter 33 from the second upper limit value to the first upper limit value. This cancels the limitation of the DC power Pad to be delivered from the power-supply adapter 2 to the charger 5.

When the negated state indicating signal TS is transmitted to the MCU 626, the MCU 626 negates the charging power limiting signal ZS after waiting for the first waiting time to elapse. The charging converter 621 restores the target value of the charging current Ich from the second target value to the first target value in accordance with the negated charging power limiting signal ZS. This cancels the limitation of the charging power Pch in the charger 5.

### 2-5. Effects of Embodiment

In this embodiment, the charging system 1 can control the charger 5 in accordance with the state of the power-supply adapter 2 simply by asserting or negating the state indicating signal TS without using a complicated communication protocol between the power-supply adapter 2 and the charger 5. In addition, the power-supply adapter 2 can control itself (more specifically, the power conversion circuit 3) in accordance with the state of the power-supply adapter 2.

In this embodiment, in response to the power-supply adapter 2 having an transitioned from the permissible-temperature state to impermissible-temperature state where the temperature of the power-supply adapter 2 is impermissible, (i) the charging power Pch is decreased in the charger 5, and then (ii) the DC power Pad being output from the power supply adapter 2 is decreased. Therefore, the charging system 1 can inhibit a situation from occurring where the DC power Pad is decreased before the charging power Pch is decreased such that the DC power Pad is insufficient for generating the charging power Pch.

In this embodiment, in response to the power-supply adapter 2 having transitioned from the impermissible-temperature state to the permissible-temperature state, (i) the DC power Pad being output from the power-supply adapter 2 is increased, and then (ii) the charging power Pch in the charger 5 is increased. Therefore, the charging system 1 can inhibit a situation from occurring where the charging power Pch is increased before the DC power Pad is increased such that the DC power Pad is insufficient for generating the charging power Pch.

In this embodiment, the power-supply adapter 2 detects the temperature of each of the primary circuit 33a and the secondary circuit 33b of the main converter 33. Thus, it is possible to more accurately detect that the temperature of the power-supply adapter 2 is impermissible compared to a case where the temperature of one part of the main converter 33 is detected.

In this embodiment, the power-supply adapter 2 ignores the event where the impermissible-temperature detection flag F2 is erroneously set or cleared due to an electrical noise. Thus, it is possible to inhibit an erroneous detection of the impermissible-temperature detected state or the permissible-temperature detected state due to an electrical noise.

In this embodiment, due to (i) the galvanic isolation provided by the main converter 33 and (ii) the optoisolator 39, the charging system 1 can inhibit the user from getting electrocuted by the AC power Pac.

In this embodiment, the charging system 1 can notify the user of the state of the power-supply adapter 2 via the adapter indicator 222.

In this embodiment, the power-supply adapter 2 can be detached from the charger 5 to be stored or carried separately from the charger 5, which can improve the convenience of the charging system 1.

### 2-6. Correspondence Between Terms

In this embodiment, the electrical cable in Overview of Embodiments is exemplified as the DC cable 23. The state indicating signal in the first state in Overview of Embodiments is exemplified as the negated state indicating signal TS. The state indicating signal in the second state in Overview of Embodiments is exemplified as the asserted state indicating signal TS. The primary winding in Overview of Embodiments is exemplified as the first winding L2. The secondary winding in Overview of Embodiments is exemplified as a combination of the second winding L3 and the third winding L4. The first portion in Overview of Embodiments is exemplified as the first heat dissipation plate 322. The second portion in Overview of Embodiments is exemplified as the second heat dissipation plate 332. The state indicating signal set to the first logic level in Overview of Embodiments is exemplified as the asserted state indicating signal TS. The state indicating signal set to the second logic level in Overview of Embodiments is exemplified as the negated state indicating signal TS. The first threshold in Overview of Embodiments is exemplified as the impermissible-temperature detection threshold TH1. The second threshold in Overview of Embodiments is exemplified as the impermissible-temperature cancellation threshold TH2. The indicator in Overview of Embodiments is exemplified as the adapter indicator 222. The first connector in Overview of Embodiments is exemplified as the DC socket 231. The second connector in Overview of Embodiments is exemplified as the DC plug 53. The container portion in Overview of Embodiments is exemplified as the battery container portion 5a. The first electronic circuit in Overview of Embodiments is exemplified as the temperature monitoring circuit 35. The second electronic circuit in Overview of Embodiments is exemplified as the adapter controller 38. The electrical signal in Overview of Embodiments is exemplified as the impermissible-temperature detection signal TD1.

### 2-7. Further Embodiments

The present disclosure is not limited to the above embodiment, but can be practiced in various forms.

In a further embodiment, the charger 5 may be a single port charger. In this case, the charger main body 51 may be configured (i) to store a single battery pack 9 and (ii) to charge the stored single battery pack 9.

In a further embodiment, the charger main body 51 may be configured to store one, two, or four or more tray units 54.

In a further embodiment, the tray unit 54 may be configured such that one, two, three, or five or more battery packs 9 are attached thereto.

In a further embodiment, in place of the state indicating signal TS, another electrical signal may be used that varies in response to the power-supply adapter 2 having transitioned to the impermissible temperature state.

In a further embodiment, the state detection circuit 4 may detect a cause that makes the temperature of the power-supply adapter 2 impermissible.

In a further embodiment, the state detection circuit 4 may detect the operation of the cooling fan in the power-supply adapter 2 as the state of the power-supply adapter 2.

In a further embodiment, the first heat dissipation plate 322 may be configured to dissipate the heat generated in the second semiconductor switch Q2 and/or the heat generated in the third semiconductor switch Q3 in addition to or in place of the heat generated in the first diode DI and the first semiconductor switch Q1.

In a further embodiment, the adapter controller 38 may send, to the indicator circuit 40, a command to indicate that the temperature of the power-supply adapter 2 is permissible in S220.

### 2-8. Supplementary Explanation

Two or more functions of one element in the aforementioned embodiments may be achieved by two or more elements, and one function of one element may be achieved by two or more elements. Furthermore, two or more functions of two or more elements may be achieved by one element, and one function achieved by two or more elements may be achieved by one element. A part of the configurations in the aforementioned embodiments may be omitted. Furthermore, at least a part of the configurations in the aforementioned embodiments may be added to or replaced by another configuration in the above-described embodiments.

What is claimed is:

1. A charging system comprising:
a power-supply adapter including:
a power conversion circuit configured (i) to receive AC power from an AC power supply, (ii) to convert the AC power into DC power, and (iii) to deliver the DC power to an electrical cable; and
a state detection circuit configured (i) to generate a state indicating signal, (ii) to transmit the state indicating signal to the electrical cable, and (iii) to vary the state indicating signal in accordance with a state of the power-supply adapter; and
a charger including:
at least one attachment configured such that at least one battery pack is detachably attached thereto, the at least one battery pack being configured to be detachably attached to an electric-powered work machine; and
a charging circuit configured (i) to receive the DC power and the state indicating signal from the power-supply adapter via the electrical cable, (ii) to generate, based on the DC power, charging power for charging the at least one battery pack, (iii) to deliver the charging power to the at least one battery pack attached to the at least one attachment, and (iv) to vary the charging power in accordance with a variation in the state indicating signal.

2. The charging system according to claim 1,
wherein the state detection circuit is configured to vary (i) the state indicating signal and (ii) an operation of the power conversion circuit, in accordance with the state of the power-supply adapter.

3. The charging system according to claim 2,
wherein the charging system has a time interval between (i) a first timing at which the state detection circuit varies the operation of the power conversion circuit in response to the variation in the state indicating signal and (ii) a second timing at which the charging circuit varies the charging power in response to the variation in the state indicating signal.

4. The charging system according to claim 3, wherein:
the charging circuit is configured to increase the charging power in response to a first waiting time having elapsed after the variation in the state indicating signal into a first state; and
the first waiting time is longer than a time required for the state detection circuit to vary the operation of the power conversion circuit so as to increase the DC power in response to the variation in the state indicating signal into the first state.

5. The charging system according to claim 3, wherein:
the state detection circuit is configured to vary the operation of the power conversion circuit so as to decrease the DC power in response to a second waiting time having elapsed after the variation in the state indicating signal into a second state; and
the second waiting time is longer than a time required for the charging circuit to decrease the charging power in response to the variation in the state indicating signal into the second state.

6. The charging system according to claim 1, wherein:
the state detection circuit includes at least one temperature sensor configured to detect a temperature at a prespecified portion in the power conversion circuit; and
the state detection circuit is configured to vary the state indicating signal in accordance with the temperature detected by the at least one temperature sensor.

7. The charging system according to claim 6, wherein:
the power conversion circuit includes:
a primary circuit including a primary winding; and
a secondary circuit including a secondary winding that is configured to be inductively coupled with the primary winding;
the at least one temperature sensor includes:
a first temperature sensor configured to detect a first temperature at a first portion in the primary circuit; and
a second temperature sensor configured to detect a second temperature at a second portion in the secondary circuit; and
the state detection circuit is configured to vary the state indicating signal in accordance with (i) the first temperature detected by the first temperature sensor and (ii) the second temperature detected by the second temperature sensor.

8. The charging system according to claim 7, wherein:
the state detection circuit is configured (i) to set the state indicating signal to a first logic level in response to either the first temperature or the second temperature having exceeded a first threshold and (ii) to set the state indicating signal to a second logic level in response to both the first temperature and the second temperature having fallen below a second threshold; and
the second logic level is different from the first logic level.

9. The charging system according to claim 1,
wherein the power-supply adapter further includes an indicator configured to indicate the state of the power-supply adapter.

10. The charging system according to claim 1, wherein:
the power-supply adapter includes an adapter main body including the power conversion circuit and the state detection circuit;
the electrical cable includes:
a first end coupled to the adapter main body; and
a second end including a first connector; and
the charger includes a second connector configured to be detachably coupled to the first connector.

11. The charging system according to claim 1,
wherein the at least one attachment includes two or more attachments configured such that two or more battery packs are detachably attached thereto.

12. The charging system according to claim 1,
wherein the charger includes a charger main body (i) including the at least one attachment and the charging circuit therein and (ii) configured to store therein the at least one battery pack attached to the at least one attachment.

13. The charging system according to claim 12, wherein:
the charger main body includes a container portion for storing the at least one battery pack therein; and
the charger includes a lid body configured to open and close the container portion.

14. The charging system according to claim 1,
wherein the power conversion circuit is configured to provide a galvanic isolation between its AC input and its DC output.

15. The charging system according to claim 1,
wherein the state detection circuit includes:
a first electronic circuit electrically coupled to the AC power supply;
a second electronic circuit electrically coupled to the electrical cable; and
an optoisolator configured to optically couple the first electronic circuit with the second electronic circuit so as to transmit an electrical signal between the first electronic circuit and the second electronic circuit.

16. A power-supply adapter comprising:
a power conversion circuit configured (i) to receive AC power from an AC power supply, (ii) to convert the AC power into DC power, and (iii) to deliver the DC power to a charger via an electrical cable; and
a state detection circuit configured (i) to generate a state indicating signal, (ii) to transmit the state indicating signal to the charger via the electrical cable, and (iii) to vary the state indicating signal in accordance with a state of the power-supply adapter.

17. A charger comprising:
at least one attachment configured such that at least one battery pack is detachably attached thereto, the at least one battery pack being configured to be detachably attached to an electric-powered work machine; and
a charging circuit configured (i) to receive DC power and a state indicating signal from a power-supply adapter via an electrical cable, (ii) to generate, based on the DC power, charging power for charging the at least one battery pack, (iii) to deliver the charging power to the at least one battery pack attached to the at least one attachment, and (iv) to vary the charging power in accordance with a variation in the state indicating signal, wherein the state indicating signal varies in accordance with a state of the power-supply adapter.

18. A method for controlling a charger, the method comprising:
transmitting a state indicating signal from a power-supply adapter to the charger via an electrical cable, wherein the state indicating signal varies in accordance with a state of the power-supply adapter; and
varying charging power in the charger in accordance with a variation in the state indicating signal, the charging power being power for charging a battery pack attached to the charger, and the battery pack being configured to be detachably attached to an electric-powered work machine.
